(19) United States
(12) Patent Application Publication
(10) Pub. No.: US 2009/0307762 A1
(43) Pub. Date: Dec. 10, 2009

(54) SYSTEM AND METHOD TO CREATE, SAVE, AND DISPLAY WEB ANNOTATIONS THAT ARE SELECTIVELY SHARED WITHIN SPECIFIED ONLINE COMMUNITIES

(75) Inventor: GEOFFREY ERIC CUDD, JR., ATLANTA, GA (US)

Correspondence Address: GEOFFREY CUDD JR., 47 LLANGOLLEN LANE, NEWTOWN SQUARE, PA, 19073, US

(73) Assignee: CHORUS LLC, ALPHARETTA, GA (US)

(21) Appl. No.: 12/133,586

(22) Filed: Jun. 5, 2008

(51) Int. Cl. H04L 9/32; G06F 17/00

(52) U.S. Cl. 726/5; 715/230

(57) ABSTRACT

A system and method for the creation and display of web annotations that are selectively shared within specified online communities is disclosed. An embodiment of the system and method include the use of a web browser plug-in that enables a computer user to create content and have that content associated with an Internet address in the form of a web note that is displayed to the user in a presentation layer over the Internet website. That web note is transmitted to a web server that stores the content and attributes of the web note in a database. When that user or another other user of the browser plug-in subsequently navigates to the aforementioned Internet address, that web note is retrieved from the database and displayed through the browser to the user in a presentation layer over the Internet website, independent of that Internet website based on user determined content sharing filters.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention relates to software processes, specifically software that enables user generated content creation and information sharing on the Internet.

2. Background of the Invention

The Internet has evolved dramatically over the past three to four years. A shift has been made from separate stores of information linked together with limited interaction toward an online community based on collaboration. Web-based communities now have the ability to create and share content with each other through tools such as social networks, wikis, podcasts, blogs, and RSS feeds.

Common browser toolbar plug-in applications such as Google Toolbar and Yahoo! Toolbar perform functions to assist in completing web forms, perform searches, launch applications, and store bookmarks. Some of these functions are achieved by storing data entered by a user in a database including bookmarks, previous searches, or form entries. Then, at a later point, this data can be retrieved and used to display content and custom functions to the user via the browser toolbar.

Desktop software programs exist which permit a computer user to generate a software note or annotation, and to attach the software note to a document of an application program or be anchored to a specific location on the computer screen independent of an application program. Such a note can be created, deleted, edited, saved, and selectively viewed. A computer user may move such a note within a document, between documents, or anywhere on the computer screen. The background color and size of a note can be saved with or without a date and time stamp. U.S. Pat. No. 6,411,310 (2002), U.S. Pat. No. 6,437,807 (2002), and U.S. Pat. No. 5,821,931 (1998), all to Berqueist et al, disclose how software programs can handle software notes in this fashion. Software notes are useful because they allow a user to describe the surrounding materials providing context and relevancy to other desktop applications and documents.

Recently, several web-based annotation programs have emerged such as Diigo (www.diigo.com), Stickis (www.stickis.com), and Protonotes (www.protonotes.com). These programs expand upon the desktop software note by allowing users to create a rectangular note and associate that note with an Internet address. When that user or another user navigates back to that Internet address, the web-based note re-appears within the browser screen.

However, these existing programs have the following limitations and constraints:
a) Those programs in the field of content creation require authorization by website content owners in order to function. The tools available for content creation are never completely independent of a website. Social networks, blogs, wikis, forums, surveys, etc. provide for user generated content, but content creation is limited in one of three ways:
   I. Content must be entered through a form or function in the website itself.
   II. Content must be entered through a widget or web-service embedded in the website that interacts with a third-party site or service.
   III. Content must be entered through a more cumbersome back-end process like FTP, SSH, email, manual intervention, etc.
b) Toolbar programs that are somewhat independent of websites do not lend themselves to a free-form style of content creation, whereas content cannot be placed in any position on a website in any size, shape, or media type. These applications that store data are limited in scope to bookmarks, previous searches, form entries, or rectangular web annotations.
c) Note software programs generally focus on an individual experience where a user creates, edits, and views notes within their own computer and documents. A few new services provide basic group sharing of note display, without the ability to specify membership in multiple groups or selectively view notes based upon note or user characteristics. Those groups are further restricted in functionality because membership in a standard group allows all other users within that group to view content created by any user within that group. This does not address the new social network paradigm that a first user may be associated with another user through their social network, but that other user could have a completely different set of connections (other users) that ideally should be restricted from seeing content created by the first user unless they also have a direct relationship to the first user.

Objects and Advantages

Several objects and advantages of the present invention are:
a) to provide a method for user generated content creation and sharing that is independent of a particular website, yet can be viewed in association with that website without a website owner's authorization or assistance;
b) to provide a method for users to share information through existing social network affiliations, online communities, or special interest groups to provide context or relevant information that supplements information on a website. This information can come from anyone independent of the website owner, and can provide unique perspectives or alternative ideas that are not moderated by the website owner;
c) to provide a method for user generated content creation that is flexible and not constrained by website forms and layouts;
d) to provide a method for user generated content to be placed at any coordinates on a browser screen and appear over the underlying website in a variety of shapes, sizes, formats, and media types;
e) to provide a method for user generated content to be viewed based upon filters that display content based on multiple group or social network affiliations and the characteristics of notes or users.

Further objects and advantages will become apparent from a consideration of the ensuing description and drawings.

### SUMMARY

In accordance with the present invention this system and method comprise a means for a user to create content in any media type, have it stored in a database and associated with an Internet address, and then later retrieved when that user or another user navigates to that Internet address and be presented to user(s) based on user determined content sharing filters.

### DRAWINGS—FIGURES

FIG. 1—depicts a browser displaying three user created web notes

FIG. 2—depicts user-defined filters for the writing and display of notes based on different segments or groups

FIG. 3—is a context diagram illustrating the high-level components of the present invention

### DRAWINGS—REFERENCE NUMERALS

10—browser toolbar plug-in
11—example of a view filter
12—insert note button
13—example of a “write-to” filter
14—example of a previously created web note
15—example of an additional view filter
16—example of the display of a partially transparent web note over a website
18—last edited author/date/time stamp
20—example of a web note being created in editing mode
22—web note formatting functions
24—delete web note function
26—save web note function
28—resize web note function
40—website content presentation layer
42—notes presentation layer
44—web browser
46—web browser toolbar plug-in
48—any web server
50—notes web server
52—notes database

### DETAILED DESCRIPTION

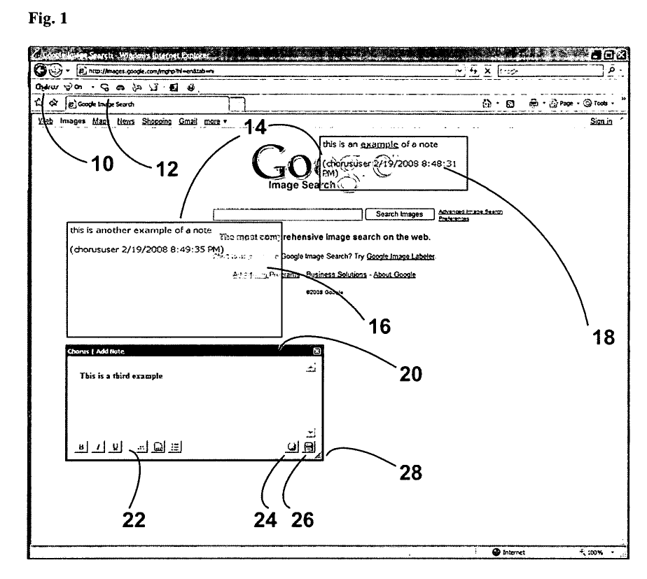

### FIG. 1—Example of a Browser Displaying User Created Notes—Preferred Embodiment

A preferred embodiment of the present invention is depicted in FIG. 1. A browser toolbar plug-in 10 is installed on an Internet browser. The browser toolbar 10 has a button or function used to create and edit web notes 12 that are comprised of content entered by a user. The example web notes 14 contain text strings entered by the user: “this is an example of a note” and “this is another example of a note.” This text string can contain hyper-links and can be formatted in a variety of fonts and sizes. In addition to text, the user-generated content within the web note 14 can consist of any variety of media types, such as drawings or images, sound clips, videos, links, etc. When web notes 14 are created or edited they can be flagged with data that records certain attributes of the web note 14 such as the author, time, and date 18 that the web note 14 was last edited. A web note 14 is displayed by the browser in a separate layer that is visible to the current user over top of website content instead of being embedded or a part of the website itself. A web note 14 can be partially transparent 16 to allow the user to maintain the ability to view the underlying website content. A web note 14 can be of variable size as is apparent by the different sizes of the example web notes 14. In addition, a web note 14 can be positioned or dragged by a user to any coordinates within the browser window.

When a web note 14 is created or saved after editing, all the attributes of the web note 14 are saved in a database such as the appearance, location, and user generated content of the web note 14. In addition, the Internet address or url of the current website accessed by the browser is associated and stored along with the web note 14 attributes in a database. When another user of a browser toolbar 10 navigates to the aforementioned Internet address, any web notes 14 associated with that Internet address are retrieved from the database and can be displayed to the user through the browser. The browser toolbar 10 can contain an on/off toggle switch to display or hide previously created web notes 14 to the user. In addition, the browser toolbar 10 can contain functions to display or hide certain web notes 14 based on filters, groups or user preferences.

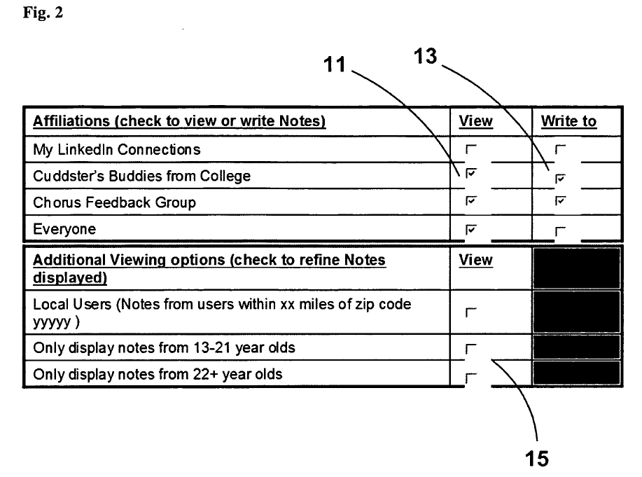

### FIG. 2—User-Managed Filters for Writing and Viewing Notes

An example of a form used to establish user preferences for writing and viewing notes is depicted in FIG. 2. The form has view filters 11 for users to specify which notes will be displayed on screen based on the group categorization of each note. The form also has “write-to” filters 13 for users to specify which groups notes are associated with when they are created. In addition to filtering notes by groups, filters can be established based on user demographics or other criteria. The form has additional view filters 15 for a user to specify which notes will be displayed on screen based on additional attributes, for example the age of the author of the note.

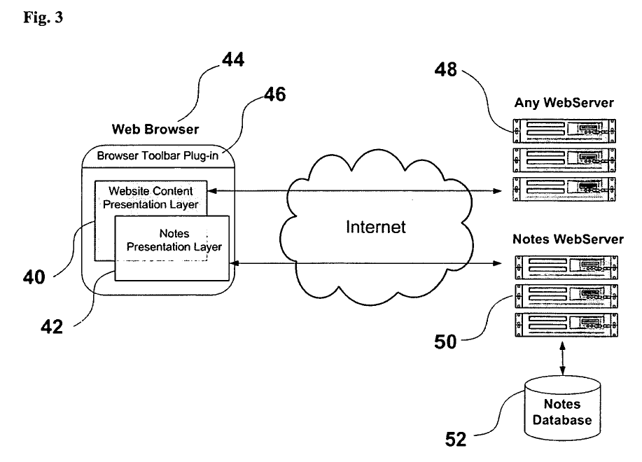

### FIG. 3—Context Diagram Illustrating the High-Level Components of the Present Invention

A context diagram of the present invention is depicted in FIG. 3. A browser toolbar plug-in 46 is installed on an Internet browser 44. The Internet browser 44 consumes Internet content over the Internet in a typical fashion. A normal website is hosted on a web server 48 and when a user navigates within their browser 44 to that Internet address, the web server 48 delivers content to the web browser 44 over the Internet to appear in the browser 44 in a standard website presentation layer 40. Meanwhile, the browser toolbar plug-in 46 communicates the Internet address that is currently accessed by the web browser 44 to a notes web server 50 that accesses a notes database 52 to determine if any web notes have been previously associated with that Internet address. If a web note has been associated with that Internet address, the notes web server 50 retrieves all the attributes of the web note from the notes database 52 and sends that information to the browser toolbar plug-in 46. The browser toolbar plug-in 46 then in turn displays the web note to the user within the web browser 44 in a notes presentation layer 42 that appears over top of the website content presentation layer 40. From a user's perspective, the web note is displayed as a partially transparent rectangle over top to the normal website content without altering the website content presentation layer 40. When there are multiple web notes 14 placed on the same screen coordinates within a web browser, those web notes 14 can be stacked and overlap one another based upon their creation dates or other criteria.

### Operation—FIGS. 1, 2, and 3

If the browser toolbar 10 is installed on an Internet browser, an Internet user can click on a button 12 within the browser toolbar 10 to create a new web note 20 in editing mode. The user can then enter content into that web note 20. In the example web note 20 the text, “This is a third example” is entered. While the web note is in editing mode 20, various formatting can be applied through web note formatting functions 22, such as modifying the font type, size, color, incorporating hyperlinks, etc. The user can drag the web note 20 to position it at any coordinates within the browser screen and can use a function 28 to modify the size of the web note 20 to a desired height and width. When a user has completed the setup of a web note 20 as desired, they can click on a save function 26. The save function 26 then records all attributes of the web note 20 including content, formatting, size and shape, position or coordinates within the browser, the Internet address currently accessed by the browser, author details, and group categorization based on the author's “write-to” filters 13 and stores these attributes in a database 52 accessed by the notes web server 50 over the Internet. Once the web note in edit mode 20 is saved, it will appear as a previously entered web note 14 without edit functions visible. When the authoring user or another user of the browser toolbar accesses this specific Internet address, the web note 20 is retrieved from the database 52 and displayed by the browser 44, based on view filter settings 11, 15, in the same coordinates with all the same attributes and content in a notes presentation layer 42 that is visible, but partially transparent over the website content. The authoring user that has originally created a web note 14 may subsequently navigate to an Internet address to retrieve and view any web notes 14 they have created that are associated with that website for editing purposes. The authoring user also has a function to delete 26 previously entered web notes 14.

### CONCLUSION, RAMIFICATIONS, SCOPE

Thus the reader will see that this system and method provide an intuitive, flexible, and effective mechanism to create and share web annotations within specified online communities. Furthermore, the system and method has the additional advantages in that
it permits the creation and sharing of content directly related or relevant to other content contained within specific Internet websites, but does not involve updates directly to those websites nor any interaction with or approval from entities maintaining those websites;
it permits the simultaneous grouping and filtering of content based upon user defined groups, existing social network affiliations, and user attributes. In this fashion, access and display of content can be limited to specified groups and personal networks of users, making that content more relevant to specific interests. At the same time, it maintains the integrity of social network affiliations allowing one-to-one content sharing between affiliated users.
it permits the generation of reports or web pages detailing the history of notes by user or by Internet site that have occurred over a period of time,
it permits the creation and sharing of user generated content in a variety of media types such as drawings or images, sound clips, videos, links, etc.

Although the description above contains many specificities, these should not be construed as limiting the scope of the invention but as merely providing illustrations of some of the presently preferred embodiments of this invention. For example, the user generated content can be of any media type, such as text, drawings or images, sound clips, videos, links, etc. Typically a note will be created in a rectangular shape, but any other shape including polygons, three-dimensional, and curved shapes can be used. Furthermore, this description should not be limited to a single browser toolbar, but would apply to any type of browser (Internet Explorer, Netscape Navigator, Mozilla Firefox, Safari), browser extension, browser plug-in, or Internet application including desktop computers and mobile devices.

Thus the scope of the invention should be determined by the appended claims and their legal equivalents, rather than by the examples given.

What is claimed is:

1. A method for creating content and associating said content with an Internet address and viewing said content, comprising the steps of:
a. generating content by processing first user input provided to web browser plug-in software by a first user of the web browser plug-in software,
b. associating the content with the Internet address and optionally, existing content, that is currently accessed by the web browser to create one or a plurality of web notes, the web notes being displayed via a web browser,
c. associating all of the attributes of the web note along with the content of web note including:
i. text, drawings or images, sound clips, videos, links, the media type of the web note, any other embedded media types within the web note, and the attributes of said media types,
ii. the dimensions, height and width of the web note,
iii. the position and coordinates of the web note within the web browser and the position relative to other web notes for the purpose of sequentially layering web notes based upon their creation dates or other criteria,
iv. the font, color, format, of any text entered,
v. data about said first user that created the web note including their userid, statistical, demographic, user preferences, profile details, and user-defined groups or social networks of which said user has membership and user affiliations within each social network,
vi. specification of which subset of the user-defined groups or social networks that said first user has membership which will be associated with the web note for viewing by other group members,
vii. the time and date that the web note was created or last edited,
d. providing the web notes to a web server, the web server storing each web note and it's said attributes in a database,
e. when a second user of the web browser plug-in software navigates to the aforementioned Internet address, the web browser plug-in software generates each of the web notes and displays the web notes to the second user according to the second user's content sharing filters which can be established based upon:
i. data about said second user including their userid, statistical, demographic, user preferences, profile details, and user-defined groups or social networks of which said second user has membership and user affiliations within each social network,
ii. attributes of the web note including groups, social networks, or user affiliations it has been associated with, its content, media type, creation date, dimensions, and number of other notes currently displayed,
iii. multiple attributes of the first user, second user, and web note simultaneously.

2. The method according to claim 1, wherein a web note includes at least one item of user generated content.

3. The method according to claim 1, wherein a web note is blank with no content.

4. The method according to claim 1, wherein said step of processing first user input comprises the step of querying said user for a user name and password and authenticating said user on said server before storing said content in a database.
